(19) United States
(12) Patent Application Publication
(10) Pub. No.: US 2016/0312742 A1
(43) Pub. Date: Oct. 27, 2016

(54) PASSIVE ELECTRICAL PROPORTIONAL TURBINE SPEED CONTROL SYSTEM

(71) Applicant: Hamilton Sundstrand Corporation, Charlotte, NC (US)

(72) Inventor: Richard A. Himmelmann, Beloit, WI (US)

(21) Appl. No.: 14/695,073

(22) Filed: Apr. 24, 2015

(51) Int. Cl. F02K 9/58; F01D 5/02; F04D 17/08; F02K 9/97

(52) U.S. Cl. CPC F02K 9/58; F02K 9/97; F01D 5/02; F04D 17/08; F05D 2220/323; F05D 2240/24; F05D 2240/128; F05D 2270/42; F05D 2270/62

(57) ABSTRACT

A turbine pump assembly includes a turbine, a centrifugal pump and a passive electrical speed control system. The passive electrical speed control system has a generator and a valve control solenoid, which receives current from the generator. A rocket thrust vector control system is also disclosed.

### BACKGROUND

This application relates to a turbine pump assembly, and more particularly to a passive electrical proportional turbine speed control system.

Rockets are maneuvered by vectoring the rocket engine thrust direction. A thrust vector control system often relies on hydraulic rams to displace the engine nozzle angle. Such hydraulic rams require high pressure hydraulic fluid pumping systems, capable of providing very high flow rates. This hydraulic flow is typically generated by a Turbine Pump Assembly (TPA), which may be powered by a fluid propellant provided by the main engine turbo-pump assembly.

A traditional TPA comprises a turbine and a hydraulic pump. Typically, the turbine operates at very high rotational speeds, such as 115,000 rpm, while the hydraulic pump operates at lower speeds, such as 6100 rpm. A gear reduction system is incorporated between the hydraulic pump and the turbine to accommodate the different operating speeds.

A traditional TPA further includes a Turbine Speed Control Valve Assembly to control the fluid flowing to the turbine, and thus the turbine rotational speed. The output power of the turbine is proportional to the mass flow rate of the propellant through the valve. In traditional systems, this valve assembly comprises a spring and a fly weight governor assembly. As the turbine spins, the fly weight governor assembly also rotates. As the fly weight governor rotates, a centripetal force is applied to arms of the fly weight governor, proportional to the rotational speed of the turbine. When the turbine and fly weight governor reach a particular speed, the fly weight governor arms push against the spring, causing the valve to partially close. As the turbine spins faster, the valve is pushed further closed. When the turbine reaches a desired speed, the fly weight governor forces are balanced against the spring force, with the valve open just far enough to maintain the turbine speed.

If additional load is applied to the TPA by the hydraulic system, the turbine will decelerate. When the turbine slows down, the centripetal force acting on the fly weight governor arms is reduced, allowing the spring to push the valve further open, allowing more propellant to flow into the turbine, causing the turbine to speed back up to the desired speed. This system is well developed, but also complex and expensive.

### SUMMARY

A turbine pump assembly comprises a turbine, a centrifugal pump and a passive electrical turbine speed control system. The passive electrical turbine speed control system has a generator and a valve control solenoid, which receives current from the generator. A rocket thrust vector control system is also disclosed.

The various features and advantages of this invention will become apparent to those skilled in the art from the following detailed description of an embodiment. The drawings that accompany the detailed description can be briefly described as follows.

### BRIEF DESCRIPTION OF THE DRAWINGS

FIG. 1 shows a perspective view of a turbine pump assembly.

FIG. 2 shows a cross section of the turbine pump assembly of FIG. 1.

FIG. 3 shows a partial view of a portion of the turbine pump assembly of FIG. 1.

FIG. 4 shows a partial view of a portion of the turbine pump assembly of FIG. 1.

### DETAILED DESCRIPTION

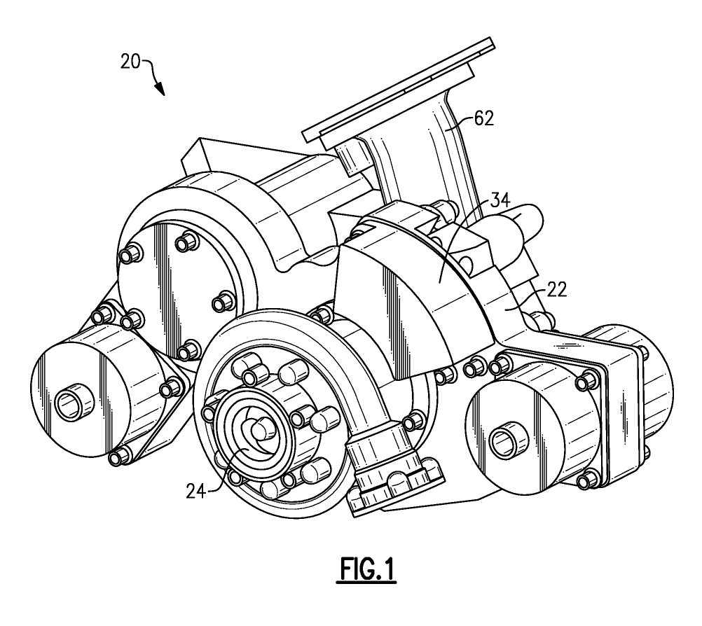

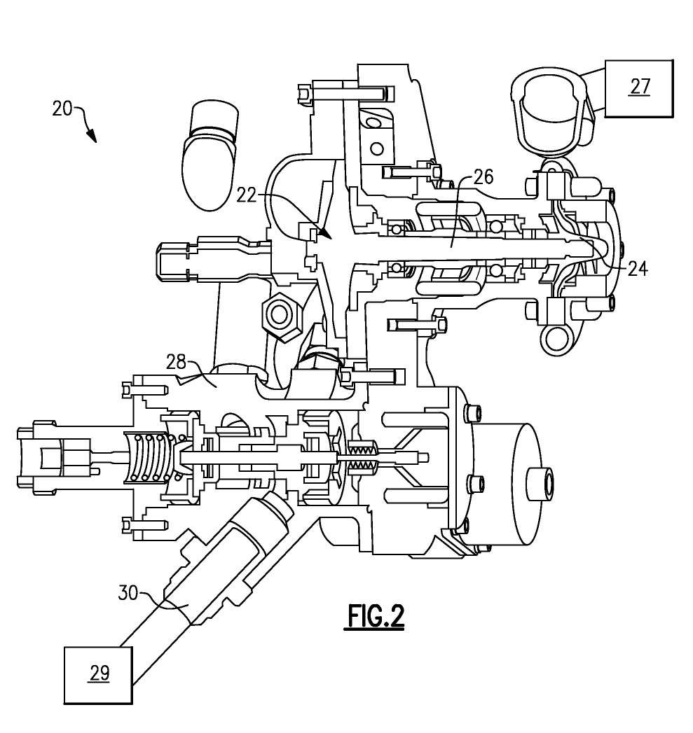

Referring to FIG. 1, a turbine pump assembly (TPA) system 20 includes a turbine 22 and a centrifugal pump 24. The TPA 20 may be powered by a propellant, such as hydrogen gas, provided by the main engine turbo-pump assembly 29 (shown in FIG. 2). Other propellants are contemplated, such as oxygen, methane, helium, or nitrogen, for example. The centrifugal pump 24 allows the TPA 20 to be much smaller than the traditional system that utilizes a variable displacement hydraulic piston pump.

Both the turbine 22 and centrifugal pump 24 are capable of operating at very high speeds, and thus are configured to rotate on a single shaft 26, as shown in FIG. 2. In one example, the operating speed of the turbine 22 and centrifugal pump 24 is between 90,000 rpm and 140,000 rpm. The turbine 22 drives the centrifugal pump 24 through the shaft 26. Hydraulic fluid from the centrifugal pump 24 is communicated to a rocket engine nozzle 27 (shown schematically) to displace an engine nozzle angle relative to a rocket core axis. The operation of the engine nozzle 27 and how the angle is adjusted are known.

Although disclosed as part of a rocket engine nozzle control, this disclosure may have application in other systems.

Since the turbine 22 and centrifugal pump 24 both operate at high speeds, and thus can operate on the same shaft 26, a gear reduction between the turbine 22 and the centrifugal pump 24 is not required. This configuration results in fewer moving parts in the overall system than a traditional TPA. The higher speeds of the single shaft 26 also prohibit the use of the fly weight governor used in traditional systems.

A speed control valve 28 controls the amount of propellant that goes to the turbine 22 from a main engine turbo-pump assembly 29 (shown schematically) through a turbine gas inlet port 30. When propellant is supplied to the turbine gas inlet port 30, propellant flows through the speed control valve 28 (which is normally fully open until an electrical signal is provided to the electrical solenoid, which pushes the valve closed) and to the turbine 22, causing the turbine 22 to rotate. As the mass flow rate of the propellant increases, the speed of the turbine 22 will increase. The speed control valve 28 controls the speed of the turbine 22 by varying the mass flow rate of the propellant.

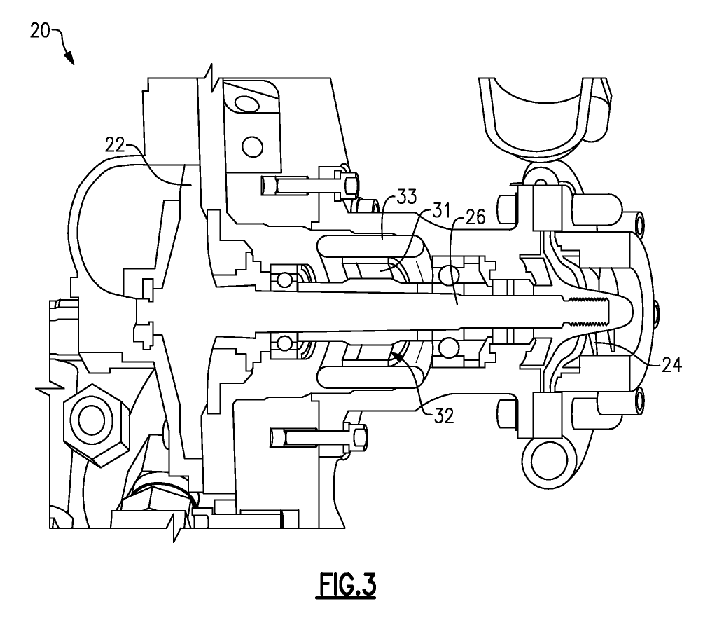

FIG. 3 shows the rotating components of the TPA 20. A generator 32 is arranged along the shaft 26 between the turbine 22 and the centrifugal pump 24. In one embodiment, the generator 32 is a high speed permanent magnet generator. In the illustrated embodiment, the generator 32 comprises permanent magnets 31 that rotate with the shaft 26, and generate a current in a stationary coil 33. The permanent magnet generator 32 generates alternating current power proportional to the rotational speed of the turbine 22. This alternating current power is passively rectified by a passive rectifier 34 (shown in FIG. 1) into direct current power proportional to the rotational speed of the turbine 22, which is then used to control the speed of the turbine 22.

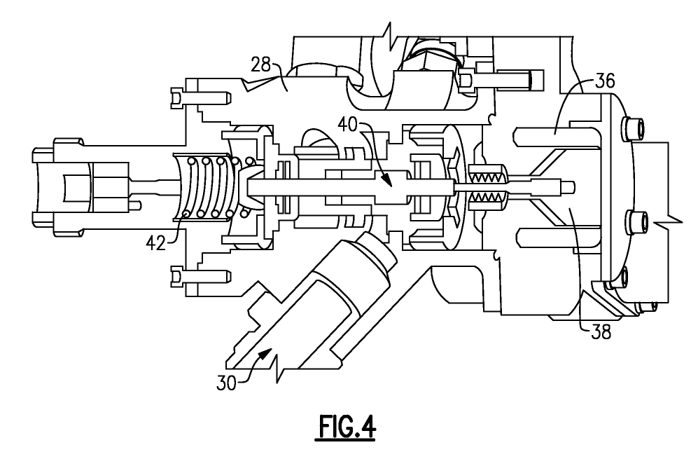

FIG. 4 shows the turbine speed control valve assembly 28, which provides passive electrical proportional turbine speed control. In the illustrated embodiment, the direct current power from the passive rectifier 34 is sent to a valve control solenoid 36. The solenoid 36 produces an electromagnetic force applied to a valve control solenoid plunger 38, which exerts an axial force that is proportional to the direct current power that is flowing in the windings of solenoid 36. Because the direct current power is proportional to the speed of the turbine 22, the axial force produced by solenoid 36 is also proportional to the speed of the turbine 22. This axial force exerted by the plunger 38 pushes against a valve spool 40, which pushes against a valve opening spring 42. In another embodiment, a linear motor or electromechanical actuator may be used to displace the valve spool 40. In the shown example, the axial force exerted by plunger 38 causes the valve spool 40 to shift to the left, compressing the valve opening spring 42 and decreasing the mass flow rate of the propellant entering the turbine 22 through the turbine inlet port 30.

As the turbine 22 spins faster, more alternating current power is generated at the permanent magnet generator 32, creating more direct current power rectified by the passive rectifier 34. As direct current power in the valve control solenoid 36 increases, the electromagnetic force applied to the valve control solenoid plunger 38 increases. The increased electromagnetic force results in an increased axial force exerted by the plunger 38. The increased axial force exerted by the plunger 38 pushes the valve spool 40, which pushes the spring 42 to push the valve 28 further closed, which decreases the mass flow rate of propellant entering the turbine 22, thus decreasing the speed of the turbine 22. When the turbine 22 reaches a desired speed, the axial force generated by the valve control solenoid 36 is balanced with the spring force of spring 42, such that the valve 28 is open just far enough to maintain a desired speed of the turbine 22.

As the speed of the turbine 22 decreases, the electromagnetic force applied to the valve control solenoid plunger 38 decreases, causing the valve spool 40 to shift in the opposite direction, decompressing the valve opening spring 42. When the valve opening spring 42 is decompressed, the mass flow rate of propellant entering the turbine 22 through turbine gas inlet port 30 increases. The desired mass flow rate and turbine speed depend on the requirements of a particular system. Details of an overspeed control system are found in co-pending U.S. patent application Ser. No. ______, entitled “Passive Overspeed Controlled Turbo Pump Assembly” filed on even date herewith. Details of a circuit breaker control valve are found in co-pending U.S. patent application Ser. No. ______, entitled “Pneumatic Circuit Breaker Based Self Resetting Passive Overspeed Control Valve for TPA” filed on even date herewith.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A turbine pump assembly, comprising:
a turbine;
a centrifugal pump; and
a passive electrical speed control system, having a generator and a valve control solenoid receiving current from the generator.

2. The turbine pump assembly of claim 1, wherein the centrifugal pump and the turbine rotate about a common shaft.

3. The turbine pump assembly of claim 2, wherein the generator is arranged along the shaft between the centrifugal pump and the turbine.

4. The turbine pump assembly of claim 1, wherein the turbine is powered by a propellant provided by a main engine turbo-pump of a vehicle.

5. The turbine pump assembly of claim 4, wherein the propellant is hydrogen gas.

6. The turbine pump assembly of claim 1, wherein the passive electrical speed control system further comprises a valve configured to meter a flow of a propellant to the turbine.

7. The turbine pump assembly of claim 1, further comprising a passive rectifier configured to convert alternating current power from the generator to direct current power.

8. The turbine pump assembly of claim 1, wherein the valve control solenoid exerts an axial force on a valve spool to vary the opening of a valve.

9. The turbine pump assembly of claim 8, wherein a valve opening spring is configured to oppose the axial force exerted by the valve control solenoid.

10. The turbine pump assembly of claim 1, wherein the turbine drives the centrifugal pump.

11. A rocket thrust vector control system, comprising:
an engine nozzle;
a turbine pump assembly having a turbine, a centrifugal pump, and a passive electrical speed control system, wherein the turbine pump assembly communicates a fluid to the engine nozzle; and
wherein the passive electrical speed control system comprises a generator and a valve control solenoid receiving current from the generator.

12. The rocket thrust vector control system as recited in claim 11, wherein the turbine is driven by a propellant that is provided by a main engine turbo-pump of a vehicle.

13. The rocket thrust vector control system as recited in claim 11, wherein the passive electrical speed control system further comprises a valve configured to meter a flow of a propellant to the turbine.

14. The rocket thrust vector control system as recited in claim 13, wherein the valve decreases the flow of propellant to the turbine when the turbine is operating above a desired speed.

15. The rocket thrust vector control system as recited in claim 11, wherein the turbine drives the centrifugal pump.
